(19) United States
(12) Patent Application Publication
(10) Pub. No.: US 2013/0038685 A1
(43) Pub. Date: Feb. 14, 2013

(54) 3D DISPLAY APPARATUS, METHOD AND STRUCTURES

(71) Applicant: Kim MATTHEWS, WARREN, NJ (US)

(72) Inventor: Kim MATTHEWS, WARREN, NJ (US)

(73) Assignee: ALCATEL-LUCENT USA INC., MURRAY HILL, NJ (US)

(21) Appl. No.: 13/209,126

(22) Filed: Aug. 12, 2011

(51) Int. Cl. H04N 13/04; H04N 13/00; H04N 5/775

(52) U.S. Cl. 348/43; 386/230; 348/51; 386/E05.07; 348/E13.001

(57) ABSTRACT

A method, apparatus and structure(s) for displaying 2D/3D images.

### TECHNICAL FIELD

This disclosure relates to systems, devices and structures for conveying a stereoscopic perception of 3-dimensional (3D) depth to a viewer.

### BACKGROUND

3D displays and systems convey stereoscopic perception of 3D depth to a viewer. A basic operational characteristic of 3D displays and systems is to present offset images that are displayed separately to the left and right eye of the viewer. The offset images are combined in the viewer's brain to present the perception of 3D depth.

Given their desirable visual attributes, 3D displays and systems are popular in the film, television and computer industries. As may be appreciated however, that while 3D displays and systems and the images produced may appeal to certain individuals, they will not appeal to others. Additionally, human tolerance to images produced by such 3D displays and systems is individualized as well. More particularly, certain individuals may become disoriented and/or physically ill when viewing images on a 3D display while other individuals may exhibit no negative effects at all.

Furthermore, it is noted that the image characteristics produced by contemporary 3D displays and systems may depend upon the physical configuration of the venue. For example, the apparent amount of parallax may change with screen size, or by how far a viewer is positioned from that screen.

### SUMMARY

An advance is made in the art according to an aspect of the present disclosure directed to structures and methods that permit an individual viewer of a 3D display to selectively adjust displayed image 3D characteristics according to that viewer's individual preferences.

A further aspect of the present disclosure is directed to methods and structures that facilitate the display of moving (motion) pictures and/or other broadcast techniques wherein images displayed may exhibit a user-selectable amount of 3D characteristics.

An exemplary instantiation of the present disclosure is directed to a visual medium comprising a number of image sequences each individual image sequence including a set of at least three individual images, each of the individual images having a different viewpoint. Advantageously, the visual medium may be any of a magnetic, optical, electronic, electromagnetic, and chemical type. Additionally, the number of sequences may be a plurality such that a full length motion picture or continuous stream of images may be included.

An alternative exemplary instantiation of the present disclosure is directed to a method for providing a plurality of individual image sequences, each individual image sequence including a set of at least three individual images, each one of the individual images having a different viewpoint. The image sequences may be retrieved from a suitable storage medium and then transmitted and/or displayed. Advantageously, the method may include receiving and/or generating an indication of a desired 2D/3DF effect and then conveying only those individual images of an image sequence which correspond to that particular indication. As may be appreciated, the plurality of individual image sequences may be displayed at a rate such that a continuous motion may be observed by a viewer of the displayed images.

Still another exemplary instantiation of the present disclosure is directed to an apparatus that receives viewer input and provides sequences of images to a display device wherein the images displayed exhibits a desired amount of 2D/3D characteristics as indicated by the viewer input.

### BRIEF DESCRIPTION OF THE DRAWING

A more complete understanding of the present disclosure may be realized by reference to the accompanying drawings in which:

FIG. 1 is schematic diagram showing images having different points-of-view, eyewear, and a viewer of the images according to an aspect of the present disclosure; and

FIGS. 2a, 2b, 2c, and 2d are schematic diagrams showing images having different points-of-view and their synchronization with the eyes of a viewer to provide a 2D/3D effect according to an aspect of the present disclosure; and

FIG. 3 is a schematic diagram showing frame sequences comprising a series of images according to an aspect of the present disclosure;

FIG. 4 is a schematic diagram showing an embodiment according to the present disclosure wherein glasses worn by a viewer are synchronized to a computer display via a wire;

FIG. 5 is a flow diagram showing a method according to the present disclosure;

FIG. 6 is depicts an exemplary apparatus according to the according to an aspect of the present disclosure; and

FIG. 7 depicts an exemplary apparatus' operational arrangement according to an aspect of the present disclosure.

The illustrative embodiments are described more fully by the Figures and detailed description. The inventions may, however, be embodied in various forms and are not limited to embodiments described in the Figures and detailed description

### DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure. Accordingly, those skilled in the art will readily appreciate the applicability of the present disclosure to a variety of applications involving motion pictures, television, computer displays, video games and other audio/video technologies, i.e., teleconferencing.

By way of additional background, it is first noted that the perception of 3D depth is accomplished by generating separate left and right perspective views. It is gradual differences between the left and right perspectives—called parallax—which provides the visual cues for perceiving depth in a 3D environment. One object of a 3D display system then is to present a left eye image to the left eye of a viewer that is isolated from a right eye image presented to the right eye of the viewer. This allows the viewer's visual system (Central Nervous System, brain, etc) to merge the two images resulting in the perception of depth or stereopsis.

An early method of presenting 3D images to a user—and one commonly associated with stereoscopy by the public—was through the use of anaglyph images. Part of anaglyph familiarity with the public was due—in part—to its use in non theatrical 3D media such as comic books and television broadcasts where polarization was impractical and because it employs the archetypical 3D glasses with red and cyan color filters—one for each eye.

With an anaglyph, two images are superimposed in an additive manner through the use of two filters, one red and one cyan.

To present a 3D stereoscopic motion picture, two images are generally projected superimposed onto the same screen through orthogonal linear polarizing filters. A viewer of the projected images wears eyeglasses having a pair of orthogonal linear polarizing filters—one for each eye. As each linear polarizing filter only passes light which is similarly polarized and blocks orthogonally polarized light, each eye of the viewer only sees one of the images which are subsequently combined by the viewer's brain. As may be appreciated, the use of linearly polarized filters requires the viewer to keep his/her head level, as tilting of the viewing filters will cause the images to “bleed” together.

Alternatively, two images may be projected superimposed onto the same screen through circular polarizing filters exhibiting opposite handedness. A viewer wears eyeglasses having a pair of circular polarizing lenses mounted in reverse—one for each eye. Accordingly, light that is left-circularly polarized is extinguished by the right-handed circular polarizing lens while light that is right-circularly polarized is extinguished by the left-handed circular polarizing lens. The result is substantially similar to that of viewing a linearly polarized projection with linear polarized glasses, except the viewer can advantageously tilt his/her head and still maintain satisfactory left/right separation and 3D effect.

More recently, a method for recording and viewing stereoscopic images in color using multichrome filters was described in U.S. Pat. No. 6,687,003. This method (ColorCode 3-D) uses amber and blue filters and unlike the earlier anaglyph systems it provides nearly full color viewing with existing television mediums. One eye of the viewer (left, amber filter) receives cross spectrum color information and the other eye (right, blue filter) receives a monochrome image. Both images are “combined” in the brain of the viewer.

With this additional background in place, those skilled in the art will quickly understand that viewers/users of such 3D systems and methods have no individual control over such systems. With respect to 3D motion pictures, a moviegoer must determine whether to attend a 3D showing of a particular motion picture in which they have no control over the 3D effects or attend a 2D showing of the same motion picture. Of course the ability to make such a choice presupposes that a movie theatre operator offers the two different showing—at considerable operational cost.

Accordingly, one solution to this set of problems according to the present disclosure is to provide the moviegoer a pair of glasses in which they can watch the 3D presentation without experiencing the 3D effect. In this manner, any personal ill effects of the moviegoer are avoided.

To overcome these ill effects, passive polarized eyeglasses are employed. More particularly—in the case where linearly polarized light has been used to generate the 3D motion picture—the polarized eyeglasses will include substantially identical polarization lenses (films, filters, etc) for each eye of the viewer. Similarly, for circularly polarized 3D motion pictures, each lens of the eyeglasses will have substantially the same circular polarizing lens (filter, film, etc). In this manner, viewers of the 3D motion picture will only see one polarization orientation and therefore—while not viewing the motion picture in 3D—will advantageously not suffer any ill effects associated with the 3D viewing.

Alternatively active eyeglasses (shutterglasses) having liquid crystal lenses have been employed with 3D projections/displays to block or pass light in synchronization with displayed images. More specifically, an alternate-frame sequencing method is employed whereby the glasses alternately shutter (darken) over one eye of a wearer—and then the other—in synchronization with the images displayed. The displayed images alternately depict different perspectives for each eye, thereby achieving a 3D effect.

According to an aspect of the present disclosure, the alternating shuttering is synchronized to a single perspective for both left and right eyes, thereby eliminating any 3D effect. Instead, what is observed by the viewer is a 2D image and consequently no ill effect of the 3D viewing is experienced.

Operationally, a pair of glasses having liquid crystal lenses are made user selectable such that they operate in either alternating shutter mode or synchronized shutter mode. In this manner when the glasses are operating in alternating shutter mode, a wearer will observe a 3D effect for suitably displayed (or projected) images. Alternatively, when the glasses are operating in a synchronized shutter mode, a wearer will observe a 2D effect for images displayed.

While these techniques according to the present disclosure so far described may satisfactorily eliminate the 3D effect and any resulting physiological ill effects for a viewer, it is noted that they do not allow a viewer to selectively adjust the amount of 3D effect experienced.

With this in mind a further aspect of the present disclosure is directed to an active display system apparatus and method that allows a viewer to select the amount of 3D effect—or none at all. More particularly, images are sequentially displayed wherein the images exhibit three or more different viewpoints. Active eyeglasses are used such that a wearer of the eyeglasses may select one of four different combinations of the displayed images.

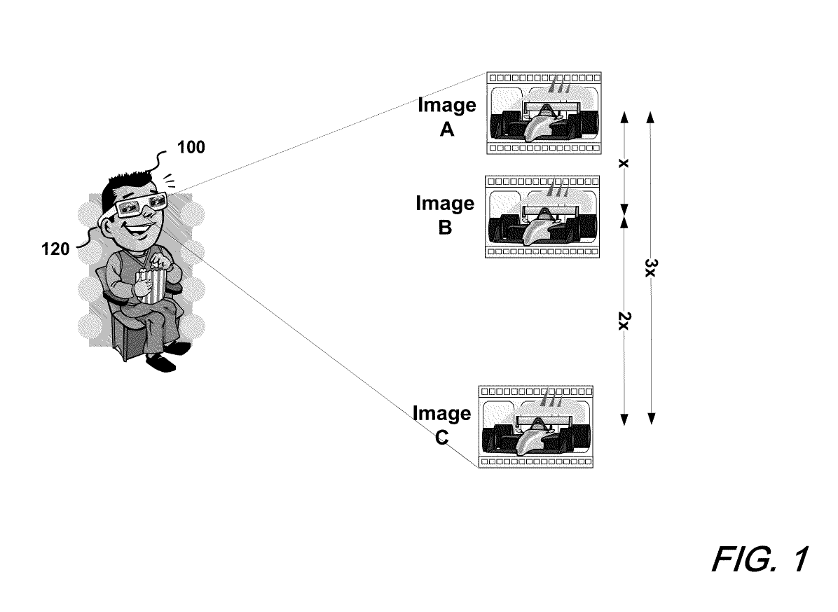

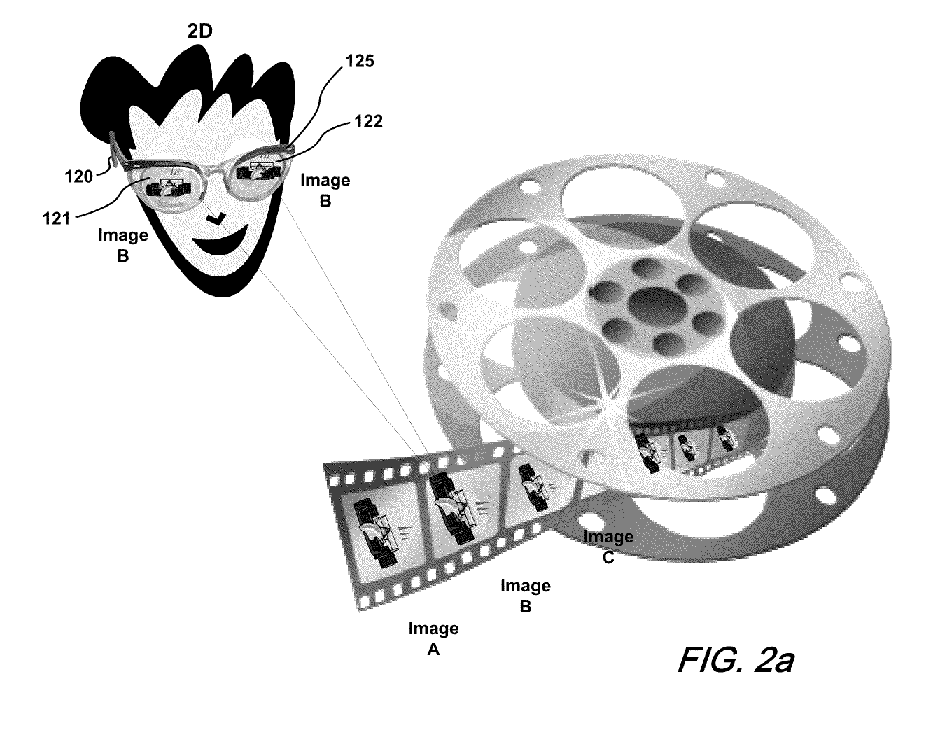

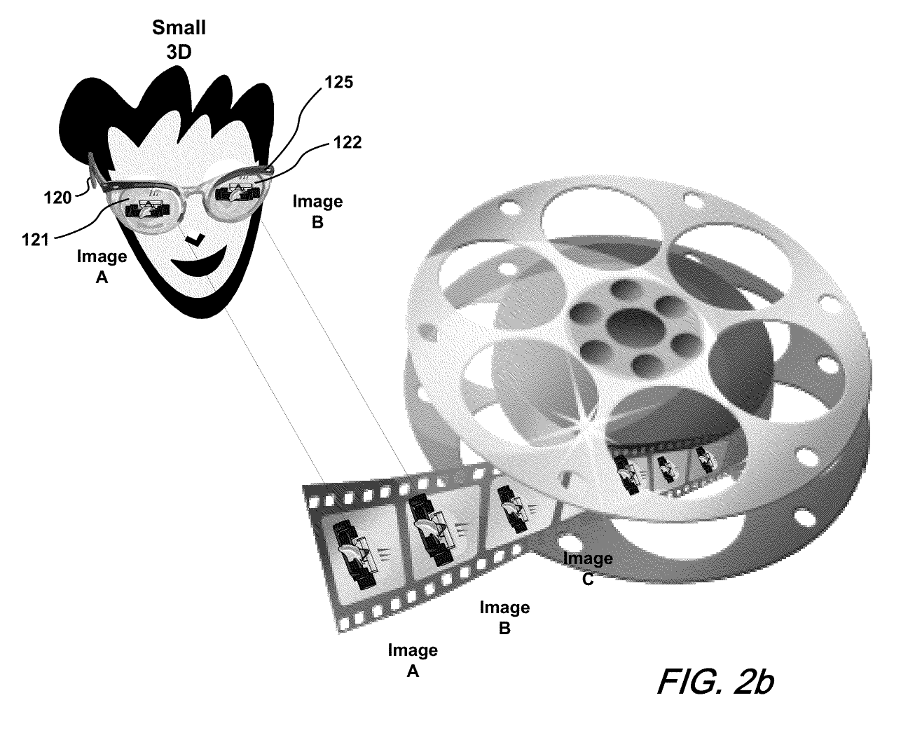

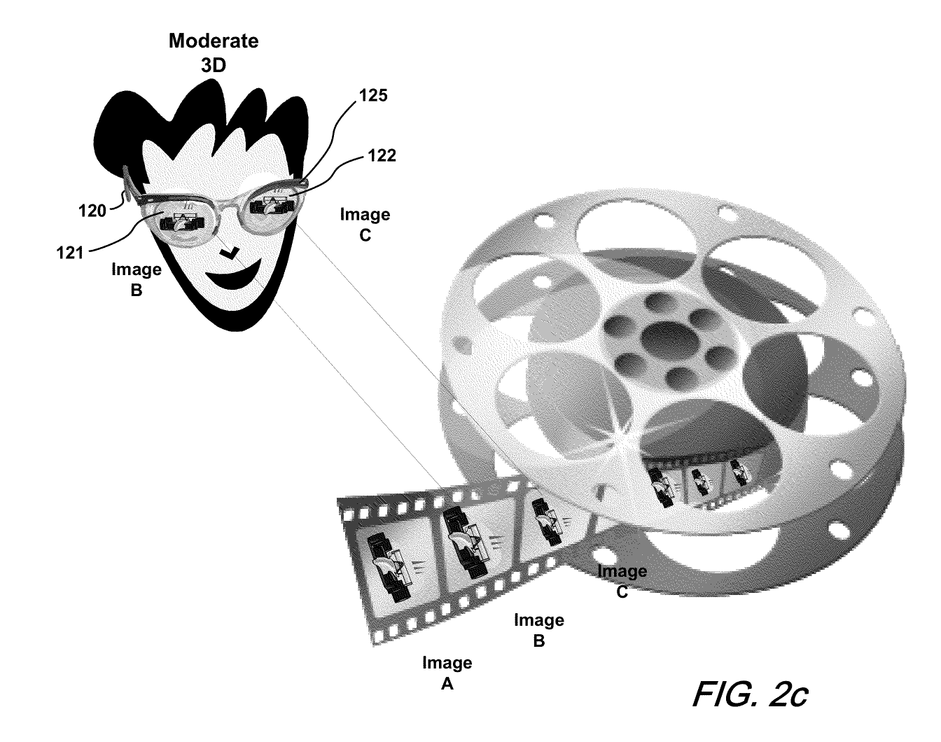

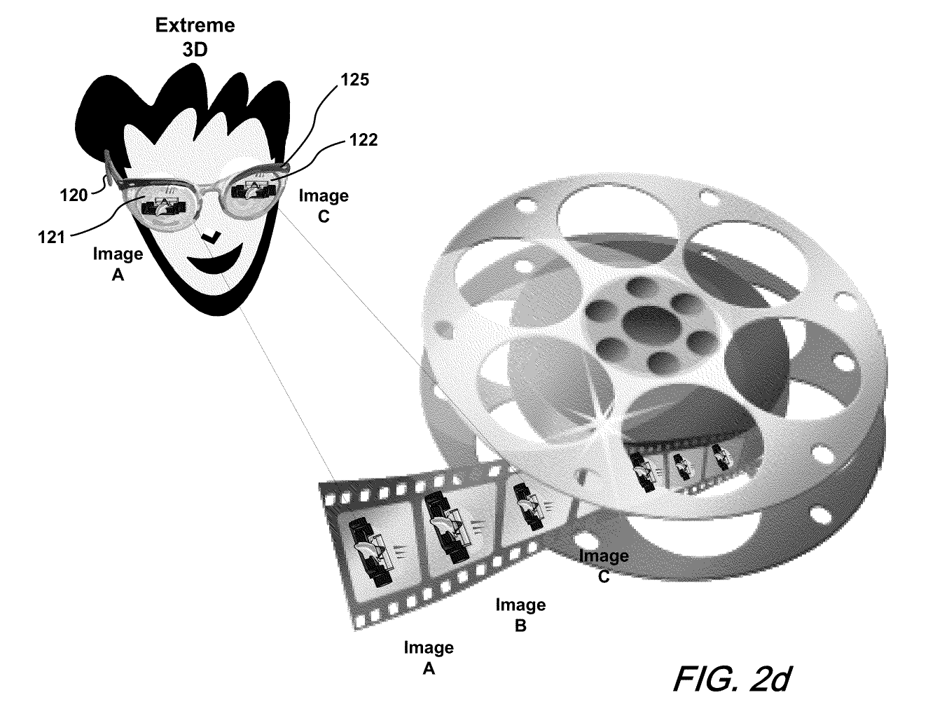

With simultaneous reference to FIGS. 1, 2a, 2b, 2c, and 2d, there is shown a schematic diagram depicting a viewer of images 100 (FIG. 1) and a sequence of images A, B, and C—each exhibiting a different viewpoint. For the purposes of this example—and according to an aspect of the present disclosure—it is noted that the viewpoint separation for each of the images is different. That is to say, the viewpoint from which each of the individual images A, B, and C are composed is different. This difference is measured as a viewpoint separation. For example, the viewpoint separation of images A and B is x, while the viewpoint separation of images B and C is 2×. Finally, the viewpoint separation of images A and C is 3×.

As may be appreciated, “standard” stereo pairs of images may be made with a two-lens camera having the lenses separated by ˜7 cm (the approximate separation of human eyes). Images having greater lens separations can be made with cameras mounted on an adjustable fixture thereby producing a desired degree or amount of viewpoint separation.

The images A, B and C are displayed in rapid succession on a reflective screen or other active display device. Active-shuttered eyeglasses 120 are worn by the viewer 100.

Each of the two individual lenses 121, 122 of the eyeglasses 120—which may comprise LCD devices—are synchronized with a particular one of the images displayed. A switch 125 or other selectable element allows a wearer to select which one(s) of the images A, B or C that the individual lenses are synchronized with.

As may be appreciated each one of the eyeglass lenses 121, 122 corresponds to a particular eye (left or right) of the wearer of the eyeglasses 120. Consequently—and with reference to Table 1—if both lenses 121 and 122 are synchronized with image B, then a 2D image will be observed by the wearer of the eyeglasses 120 as depicted in FIG. 2a.

TABLE 1
Right/Left Eye Image/Viewpoint Separation and 3D Effect

| Right Eye | Left Eye | Viewpoint | |
|---|---|---|---|
| Synchronized | Synchronized | Separation | Comment |
| B | B | 0 | 2D |
| A | B | x | Small 3D |
| B | C | 2x | Moderate 3D |
| A | C | 3x | Extreme 3D |

If however, both lenses are not synchronized to the same image, then the wearer of the shutter-glasses will experience a 3D effect due to the differences in viewpoints of the different images seen by each eye. In this manner, the lenses are shuttered such that each eye sees only a particular image and hence viewpoint of the image. Accordingly, if the right eye shutter is synchronized to image A and the left eye shutter is synchronized to image C, then the wearer's left eye will only see image C and the wearer's right eye will only see image A and the wearer will “observe” an image having an extreme 3D effect such as that shown in FIG. 2d.

Similarly, if the lenses are shuttered such that the right eye of the wearer only sees image B and the left eye of the wearer only sees image C, then the wearer will observe an image having a relatively moderate 3D effect as depicted in FIG. 2c.

Finally, if the lenses are shuttered such that the right eye of the wearer only sees image A and the left eye of the wearer only sees image B, then the wearer will observe an image having a relatively small 3D effect as depicted in FIG. 2b.

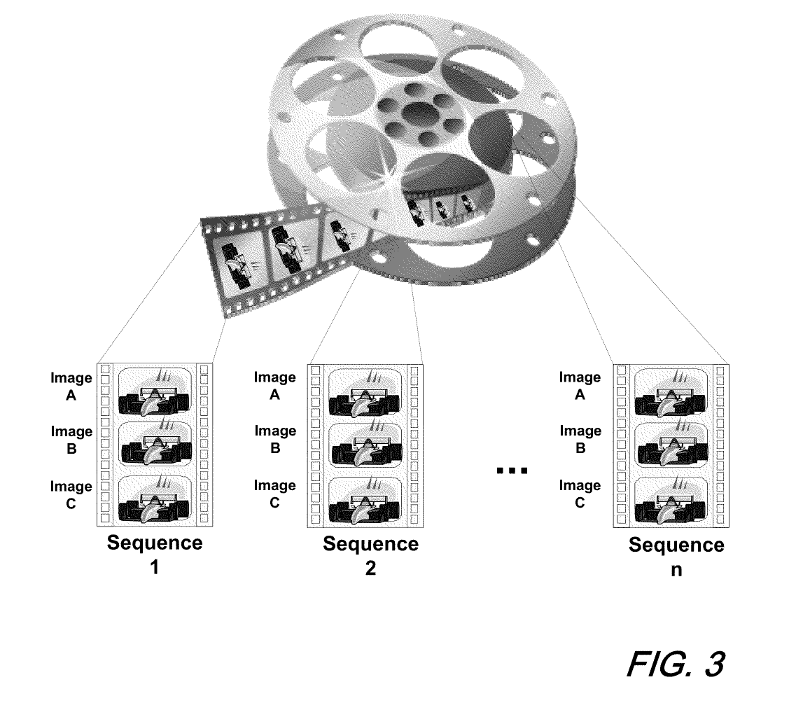

Turning now to FIG. 3, there is shown a number of frame sequences comprising a series of images according to an aspect of the present disclosure. As depicted in the FIG. 3, the images are shown as part of a film, or motion picture. Those skilled in the art will readily understand that such a film, movie, or motion picture, is simply a series of still (or moving) images. It is generally produced by recording photographic images with cameras, or by creating images using animation effect, visual effects, or computer generated. Of course films are made from a series of individual images (frames). When these images (frames) are shown rapidly in succession, a viewer has the illusion that motion is occurring. The viewer cannot see flickering between frames due—in part—to an effect known as persistence of vision whereby the eye retains a visual image for a period of time after the source of that image has been removed. While in this example shown in FIG. 3 is that of a film—those skilled in the art will of course appreciate that the present disclosure and example is applicable to any suitable medium for a sequence of images such as film, disk, tape, DVD, CD, whether chemical, electronic, optical, magnetic, electronic/electromagnetic transmissions, or any known image storage/playback/transmission, system etc.

As shown in that FIG. 3 and according to an aspect of the present disclosure, the film shown comprises a series of image sequences which have been designated Sequence 1, Sequence 2, . . . Sequence n. Each individual sequence further includes a series of images, namely Image A, Image B, and Image C. The images within a particular sequence (e.g., Sequence 1) are substantially identical but for a different 3D perspective or point of view or viewpoint separation. That is to say, the principle difference between Image A and Image B, and/or Image C in a particular Sequence is that each one of the individual images comprising the sequence generally exhibits a different viewpoint separation. As described with respect to the earlier discussed FIG. 2(a), (b), (c), and (d), depending upon which particular image the eye(s) of a viewer see, a different amount of 3D effect (or none at all) will be observed by that viewer.

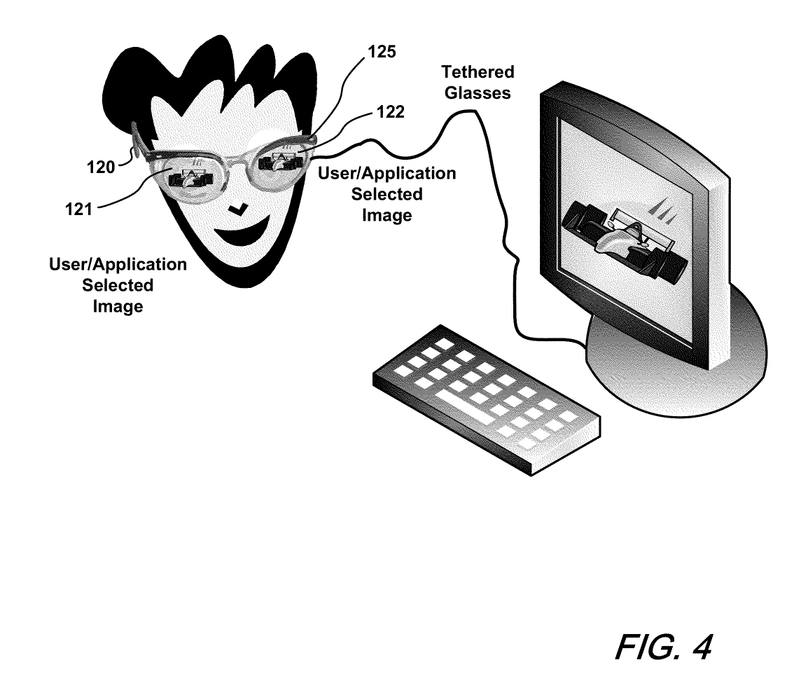

Turning now to FIG. 4, there is shown an alternative arrangement/configuration according to an aspect of the present disclosure. As shown in that FIG. 4, a computer display device is employed to display images for a viewer wearing variable shutter glasses as previously described. The glasses are shown tethered or wired to the computer display system such that the individual lenses may be controllably shuttered by the computer system. And while the glasses are shown wired to the computer system, those skilled in the art will readily appreciate that wireless mechanisms may be employed as well. For example, well known Bluetooth, wi-fi or other wireless formats/protocols may be employed to effect communication between the glasses and the computer system.

In this manner a viewer of the computer display may indicate his/her preference for 2D/3D image display via the glasses (switch, etc) and that preference may be indicated to the computer display system such that the glasses may synchronize with the displayed images. Consequently, an appropriate lens of the shutter glasses may be synchronized with an appropriate image displayed such that the degree of 2D/3D may be perceived by the viewer.

As noted previously, the stream of images that are displayed by a display device may be done in sequences, wherein each individual sequence comprises a series of images—each image having a different viewpoint separation. When used with shutter glasses according to the present disclosure, individually shuttered lenses of the shutter glasses regulate/determine which image(s) are seen by an individual eye of the viewer. In those situations where three or more images comprise an individual sequence, the glasses shutter such that only the appropriate images are seen by the appropriate eye(s), even though all of the images of a sequence may be sequentially displayed on the particular display device.

With this in mind, it is noted that the computer display system such as that shown in FIG. 4 when combined with tethered/wired or wireless shutter glasses advantageously need only display those images depicting the degree of 2D/3D separation as indicated by the shutter glasses (or other mechanism such as an application running on the computer system)

More particularly—and for the purposes of this example only—we assume that a viewer only desires to see a “normal” 3D image. As previously noted, when such a normal 3D is desired, only images A and B are seen by the right and left eyes of the viewer respectively. Notwithstanding this, when displayed as part of a motion picture—for example—as part of an overall film, all three images of an individual sequence, namely Image A, Image B, and Image C are shown/displayed/projected. The shutter glasses synchronize the particular image with the particular eye of the viewer such that the desired degree of 2D/3D is perceived.

When arranged in the manner depicted in FIG. 4 however, advantageously only those images required by the particular viewer selection need be displayed on the computer display system. More particularly, and continuing with the assumptions above whereby a normal or small 3D effect is desired, the viewer may make such selection via switch on the shutter glasses—for example—or through software mechanisms such as via keyboard. As a result, the computer display system is notified of the degree of 3D desired and therefore can display in sequence only those images (Image A and Image B) which are required to produce that effect in conjunction with the shutter glasses. Accordingly, while a computer file or medium may contain a series of image sequence wherein each sequence has a number of individual images exhibiting a different viewpoint separation, only those individual images which are required to produce a desired visual effect need be displayed.

It is noted that while to this point the viewer of the images has been shown to be generally co-located with the source of those images, the present disclosure is not so limited. For example, and with continued reference to FIG. 4, if the computer display system were receiving a sequence of images transmitted (via cable TV or satellite—for example), the computer display system may signal the source of the series of images as to the viewer's 2D/3D selection such that only those individual images necessary for the display of the selected 2D/3D need be transmitted/received and locally displayed for a viewer.

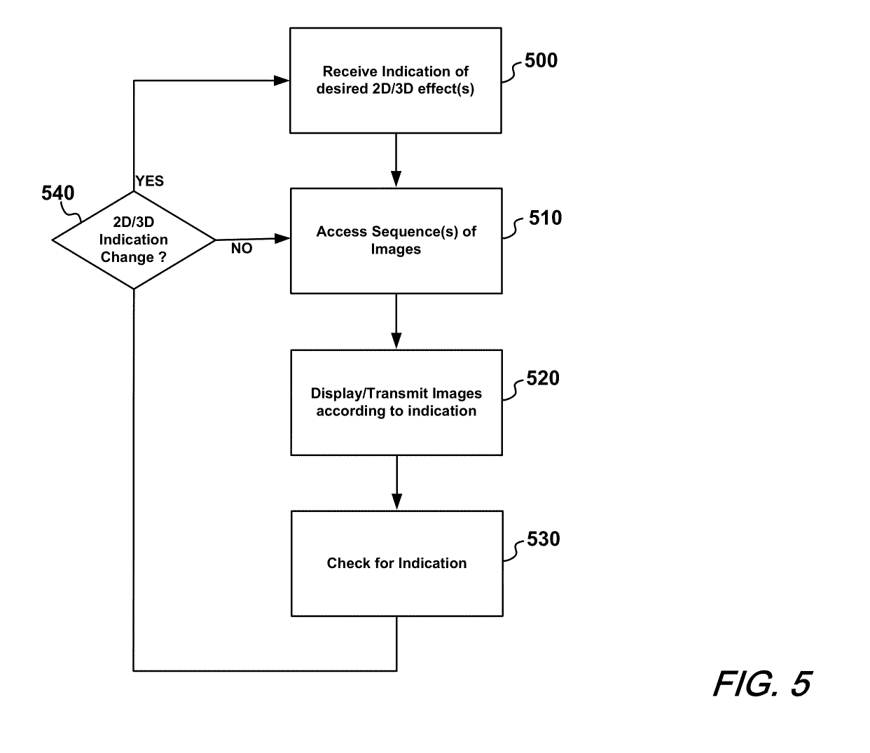

A flowchart depicting an exemplary method according to the present disclosure is depicted in FIG. 5. While not specifically shown in the flow chart, a plurality of individual image sequences, each sequence including a set of at least three individual images, wherein each one of the individual images has a different viewpoint is stored in any of a variety of known media and retrievable or otherwise accessible or receivable.

Prior to accessing the sequences, an indication of a desired 2D/3D effect may be received (Block 500) and the sequences are then accessed (Block 510). Images within the sequences corresponding to the indication are then displayed and/or transmitted as desired (Block 520). Further checks for a change in indication may be made (Block 530), and subsequent images corresponding to that change in indication may be accessed and then displayed and/or transmitted.

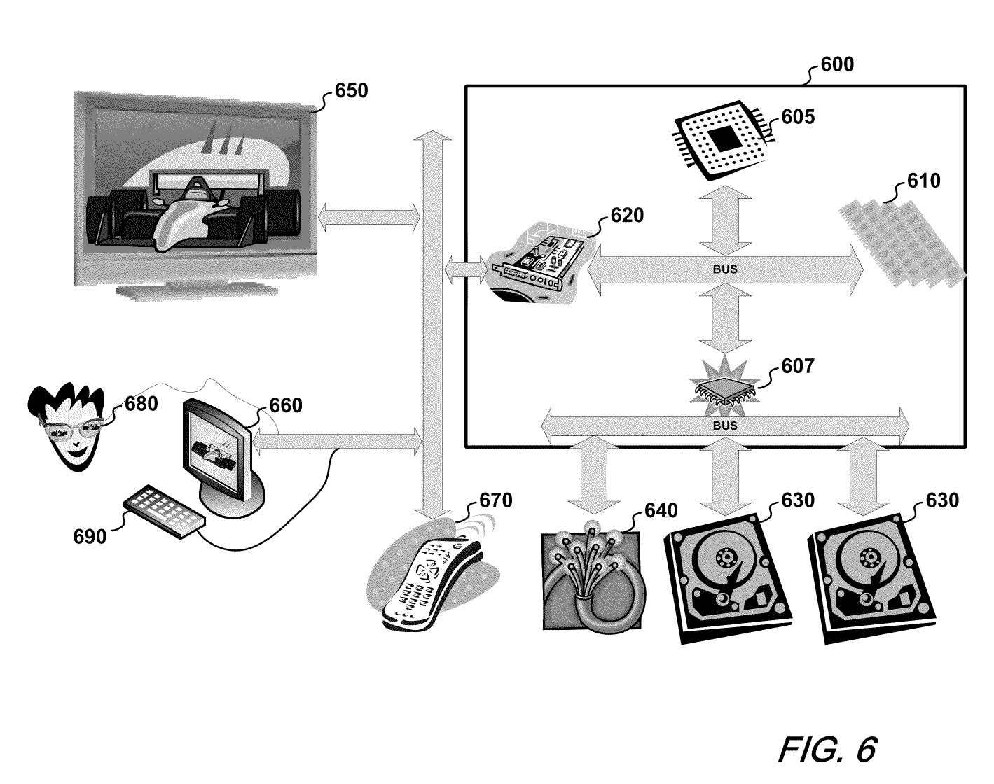

FIG. 6 depicts an exemplary apparatus 600 according to an aspect of the present disclosure. More particularly, such an exemplary apparatus 600 may include Processing Unit 605 (i.e., Central Processing Unit), memory 610, Input/Output structures 620, and/or controllers 607 which are interconnected via one or more interconnects (BUS) to input/output devices which may include, by way of example only, storage devices 630 (i.e., disks), and network interfaces 640. As may be appreciated by those skilled in the art, this architecture and inventory is not meant to be in any way limiting. Accordingly, those skilled in the art will further appreciate that such an apparatus may be constructed from any of a variety of known components/structures/methods such that the resulting apparatus has the ability to execute and operate via programmed control (software/firmware) and may be implemented as a computer, intelligent device, and/or what is commonly known in the art as a “settop box”.

Input/output control functions provided by the apparatus 600 include a display 650, 660, which may be stand alone (i.e., a television or other display) or as part of a computer arrangement. Still further, such display function may be provided by a display worn by a viewer, i.e., display glasses 680. Input to the apparatus which may provide viewer preferences (i.e., degree of 2D/3D effect) may be provided by switch on glasses 680, keyboard 690, or other “remote” controller 670. And while the input devices are shown as being tethered, those skilled in the art will appreciate that any of a variety of wireless technologies are available which provide mechanisms indicative of viewer preferences to apparatus. Finally, it is noted that while the apparatus 600 is shown as a standalone device, those skilled in the art will of course appreciate that such an apparatus may be further integrated into a display, such as the one shown 650.

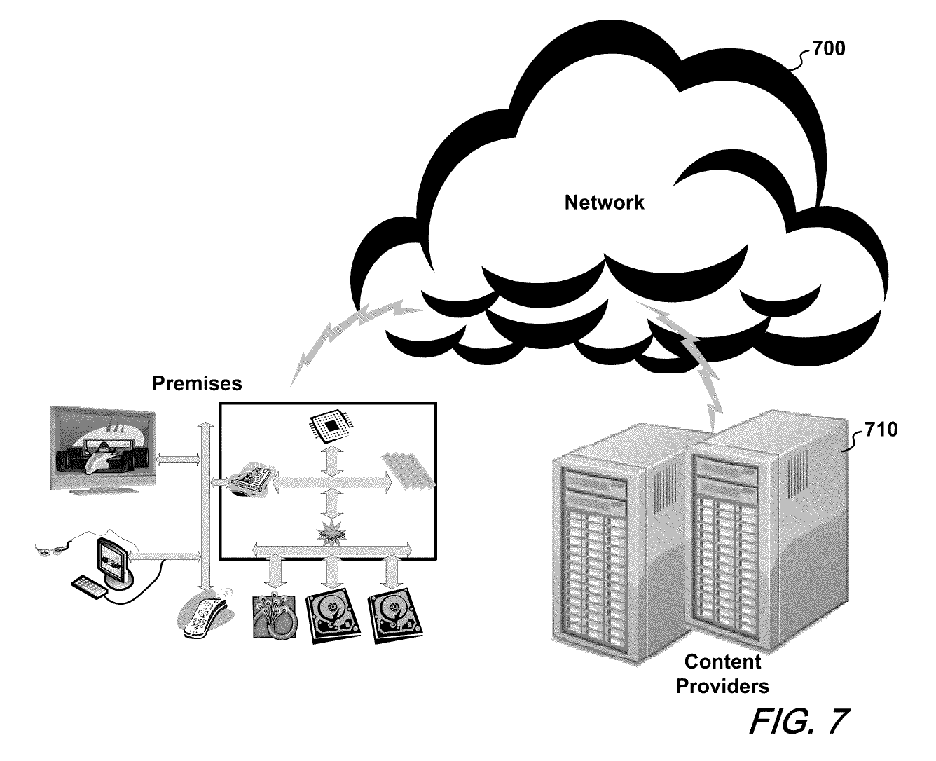

With reference now to FIG. 7, there is depicted an arrangement with the premises apparatus shown in FIG. 6, integrated into a larger network 710 (i.e., internet, intranet, etc) such that content may be provided by one or more content providers 710. With this arrangement, user preferences may be provided to the content providers, such that desired 2D/3D effects are conveyed to a viewer at the premises.

At this point, while we have discussed and described the invention using some specific examples, those skilled in the art will recognize that our teachings are not so limited. Accordingly, the invention should be only limited by the scope of the claims attached hereto.

1. A visual medium comprising:
a number of image sequences each individual image sequence including
a set of at least three individual images, each of the individual images having a different viewpoint.

2. The visual medium of claim 1 being one selected from the group consisting of:
magnetic, optical, electronic, electromagnetic, and chemical.

3. The visual medium of claim 1 wherein the number of sequences is a plurality.

4. A method comprising the steps of:
providing a plurality of individual image sequences, each individual image sequence including
a set of at least three individual images, each one of the individual images having a different viewpoint.

5. The method of claim 4 further comprising the step of:
retrieving from a suitable storage medium, the plurality of individual image sequences.

6. The method of claim 5 further comprising the step of:
transmitting the plurality of individual image sequences.

7. The method of claim 5 further comprising the step of:
displaying the plurality of individual image sequences.

8. The method of claim 4 further comprising the step of:
receiving an indication of a desired 2D/3D effect;
retrieving from a suitable storage medium, the plurality of individual image sequences; and
conveying only those individual images of an image sequence which correspond to the indication.

9. The method of claim 7 wherein said plurality of individual image sequences are displayed at a rate such that a continuous motion is observed by a viewer of the displayed images.

10. A 2D/3D method comprising the steps of:
obtaining an indication of a desired 2D/3D effect;
accessing a plurality of individual image sequences, each individual image sequence including at least three individual images, each one of the individual images having a different viewpoint;
conveying particular ones of the individual images as determined by the obtained 2D/3D indication.

11. The method according to claim 10 further comprising the steps of:
checking for a change in indication of the desired 2D/3D effect;
conveying particular ones of the individual images as determined by a changed indication.

12. The method of claim 10 wherein the conveying includes displaying the particular ones of the individual images

13. The method of claim 10 wherein the conveying includes transmitting the particular ones of the individual images via a suitable transmission medium.

14. A apparatus for displaying 2D/3D images comprising:
a display system for visually displaying a plurality of individual image sequences, each individual image sequence including at least three individual images, each one of the images having a different viewpoint; and
a selector for determining which one(s) of the individual images within each sequence are to be visually displayed;
such that a viewer of the images visually displayed may experience a different amount of 2D/3D effect as determined by the selector.

15. The apparatus of claim 14 further comprising:
a storage system for storing the plurality of individual image sequences.

16. The apparatus of claim 15 further comprising:
viewer eyewear which synchronizes the viewing of particular ones of the displayed images to a particular eye of a wearer of the viewer eyewear.

17. The apparatus of claim 16 wherein the viewer eyewear comprises a selector for determining which particular eye of the wearer is synchronized to which image within each sequence.

18. A computer readable medium comprising:
a plurality of image sequences wherein each individual image sequence includes
a set of at least three individual images, each of the individual images having a different viewpoint.

19. The computer readable medium according to claim 18 wherein each of the individual images of a particular set is of a common scene, wherein each individual image exhibits a different viewpoint of that common scene.

20. A apparatus comprising:
a processor;
logic encoded on one or more tangible media for execution by the processor, and when executed operable to:
receive a plurality of individual image sequences, each individual image sequence including at least three individual images, each one of the images having a different viewpoint; and
providing selected one(s) of the individual images to a display system for visually displaying the selected one(s) of the individual images.

21. The apparatus of claim 20 wherein upon execution of the logic by the processor is further operable to:
receive an indication of a viewer preference; and
selecting the individual images based on the indication.

22. The apparatus of claim 21 further comprising:
a visual display for displaying the selected one(s) of the individual images.

23. The apparatus of claim 21 wherein the indication of viewer preference is indicative of an amount of 2D/3D effect experienced by the viewer of the displayed images.
